(19) United States
(12) Patent Application Publication
(10) Pub. No.: US 2006/0269762 A1
(43) Pub. Date: Nov. 30, 2006

(54) Reactively formed integrated capacitors on organic substrates and fabrication methods

(76) Inventors: Markondeya Raj Pulugurtha, Atlanta, GA (US); Devarajan Balaraman, Chandler, AZ (US); Rao Tummala, Stone Mountain, GA (US); Isaac R. Abothu, Atlanta, GA (US)

Correspondence Address: Law Offices of Kenneth W. Float, 2095 Hwy. 211 NW, #2F, Braselton, GA, 30517, US

(21) Appl. No.: 11/363,334

(22) Filed: Feb. 27, 2006

Related U.S. Application Data
(60) Provisional application No. 60/658,051, filed on Mar. 2, 2005.

(51) Int. Cl. B32B 15/04

(52) U.S. Cl. 428/457

(57) ABSTRACT

Disclosed are organic-compatible thin film processing techniques with reactive (such as Ti) layers for embedding capacitors into substrates. Hydrothermal synthesis allows direct deposition of high-k films with capacitance density of about 1 μF/cm² on organic substrates. This is done by reactively growing a high-k film from Ti foil/Ti-coated copper foil/Ti precursor-coated organic substrate in an alkaline barium ion bath. Alternatives may be used to address multiple coatings, low temperature baking, low temperature pyrolysis with oxygen plasma, etc. Sol-gel and RF-sputtering assisted by a reaction with the intermediate layer and a foil transfer process may be used to integrate perovskite thin films with a capacitance in the range of 1-5 μF/cm². Thermal oxidation of titanium foil/Ti-coated copper foil/Ti-coated organic substrate with a copper conductive layer is also a reactively grown high-k film process for integrating capacitance of hundreds of nF with or without using a foil transfer process.

### STATEMENT REGARDING FEDERALLY SPONSORED RESEARCH OR DEVELOPMENT

This invention was made in part with government support under Contract Number EEC-9402723 awarded by the National Science Foundation. Therefore, the government may have certain rights tin this invention.

### BACKGROUND

The present invention relates generally to hydrothermal or thermal or plasma-reaction or solid state chemical reaction derived integrated capacitors and fabrication methods relating thereto on organic substrates or inorganic substrates like silicon and glass. The reacting species can be based on Ti, Nb, Zn, Cr, Si, Ni, Ta or other similar metals or their derivative organic precursors. The substrates can be both rigid or flex.

Power and signal integrity issues dominate the high-speed digital/RF systems of the future as integrated circuits (ICs) move to higher power at lower voltages. Major system, packaging and material companies spend millions of dollars every year to address the power integrity problem. It is well-known that low impedance power distribution network is critical to supply noise-less power to the ICs. In order to achieve the required low impedance, it is essential to have ultra-thin high-k films, as close to the IC as possible, using an efficient low-cost process. This is a billion dollar problem that has been plaguing the industry for the last few decades. It would be desirable to have a simple process for integrating high-k films on organic printed wiring boards in any layer, as closely to the IC as required.

Currently, decoupling capacitors are manufactured as discrete components and assembled on the boards using surface mount techniques. With increasing microprocessor speeds, the performance of these capacitors becomes inadequate due to parasitic inductance associated with discrete components. In the past decade, there have been efforts to embed the capacitors into the substrate, in the form of thin and thick films. One of the major constraints in the choice of thin film synthesis technique comes from the currently popular organic-based substrate material. The use of an organic substrate restricts the processing temperature to under 2200° C. Unfortunately, most high-k thin films are ceramic-based and require processing temperatures of several hundreds of ° C. Hence, there has been tremendous interest in synthesizing polymer-based high-k films or high-k films on free standing foils without temperature constraints and subsequently integrating the foils into organic boards. Currently, efforts are ongoing to commercialize ceramic-polymer thick films. Such films offer limited capacitance and require elaborate processing that includes dispersion of ceramic fillers in the polymer and casting the resulting suspension into thick films on appropriate electrode foils. The same applies to sol-gel films on metal foils although much higher capacitance densities are possible in case of sol-gel films.

Major limitations of ferroelectrics are their low breakdown voltages and frequency dependent properties. Paraelectric titania has ten times higher breakdown strength than barium titanate and stable dielectric properties at high frequencies. These advantages make this material and process, a very attractive material for embedded decoupling capacitors.

The benefits of embedded decoupling capacitors are well known as are the barriers to realizing them—non-availability of low cost organic compatible material that can achieve the required capacitance densities and a reliable process to integrate them. Ceramic-polymer nanocomposite approaches pursued by various research groups over the past decade, have enjoyed moderate success with a maximum capacitance density of about 10 nF/cm². Nanocomposite technology, however, may not be able to meet the impedance requirements of future high-speed processors. Sub-micron thick films of barium titanate and barium strontium titanate with k in the order of 300-1000 can potentially achieve capacitances of 5 μF/cm² and hence satisfy the requirements for most integral capacitors with low loss. Several material/packaging/system companies in US and around the world today are investigating ceramic-based thin films (<1 μm) for embedded capacitor applications. Currently available processes for thin film synthesis require either high process temperatures or expensive vacuum chambers or both, and therefore are not compatible with low-cost large-area organic PWB processes. Clearly novel PWB-compatible low-cost processes need to be explored to directly embed high dielectric constant ceramic films into organic build-up layers.

The improved electrical performance of embedded decoupling capacitors arises from the low inductance due to elimination of leads and traces associated with surface mount capacitors.

Dielectric characterization of hydrothermal films up to 8 GHz and simultaneous switching noise simulations were reported at the 54th ECTC. Successful implementation of embedded hydrothermal barium titanate capacitors, in addition, would require the films to exhibit reasonable breakdown voltages and low leakage currents at operating voltages. The yield on large area substrates should also be addressed to enable scaling of this novel technology to large area manufacturing. The DC leakage characteristics of the films are dependent on defect structure and stoichiometry of the films, which in turn depend on the process conditions. A systematic study of the effect to the above variables will shed light on the leakage mechanisms and ways to minimize leakage current and improve the breakdown voltages. For sol-gel films, divalent dopants can compensate for the oxygen vacancies and improve the DC leakage properties.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates exemplary organic-compatible capacitor structures;

FIG. 2 shows the microstructure of an exemplary film;

FIG. 3 illustrates DC leakage characteristics of exemplary hydrothermal films;

FIG. 4 shows the XPS depth profile of exemplary hydrothermal films synthesized in 2M Ba(OH)₂ solution at 95° C.;

FIG. 5 illustrate the microstructure of films thermally grown on titanium foil;

FIG. 6 illustrates an XRD pattern of exemplary thermally oxidized titanium foils showing a mixture of titanium oxide phases;

FIG. 7 shows leakage current characteristics of thermally grown titanium oxide films;

FIG. 8 shows a SEM micrograph of sol-gel films showing nano-grained sol-gel barium titanate;

FIG. 9 shows an as-deposited morphology of strontium titanate films RF-sputtered at 350° C. on nickel coated copper foils;

FIG. 10 shows the structural evolution of sol-gel barium titanate films with annealing times; and

FIG. 11 shows an example of reactively grown capacitors integrated on organic substrates.

### DETAILED DESCRIPTION

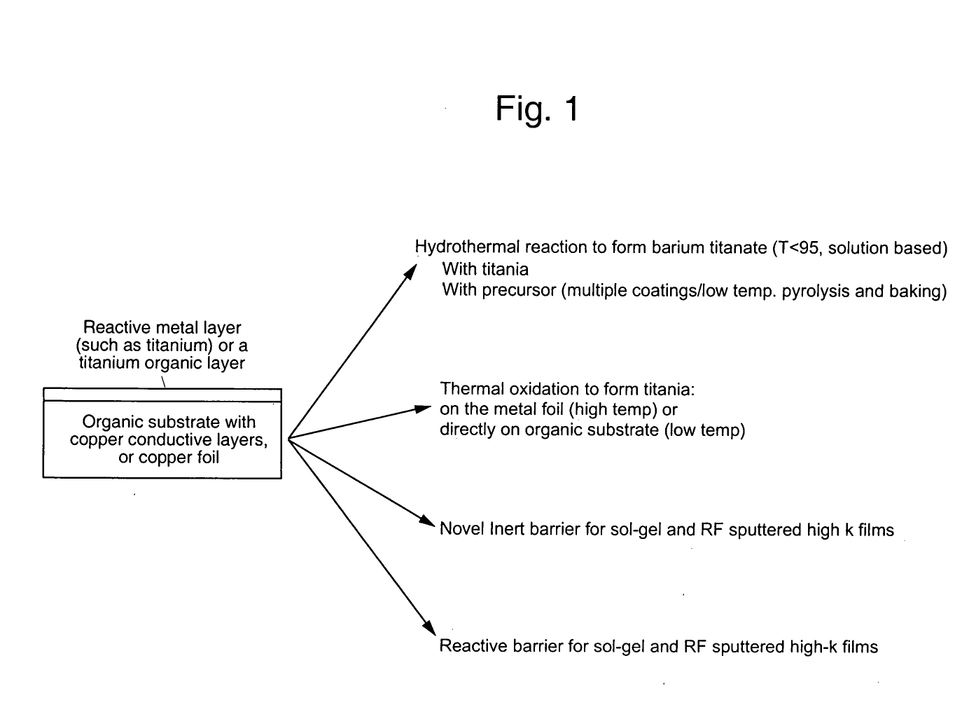

Disclosed herein are organic-compatible thin film processing techniques for embedding capacitors into organic printed wiring boards (PWBs). FIG. 1 illustrates exemplary organic-compatible capacitor structures made using the thin film processing techniques. Hydrothermal synthesis allows integration of pure nano-grained barium titanate films with capacitance density of about 1 μF/cm². Sol-gel and RF-sputtering in conjunction with a foil transfer process may be used to integrate a variety of perovskite thin films with a capacitance in the range of 0.1-5 nF/cm². Thermal oxidation of titanium foil is also a viable process for integrating capacitance of hundreds of nF using a foil transfer process. The dielectric properties of the films synthesized by these techniques as a function of various process parameters are also discussed below. Observed dielectric properties such as dielectric constant, leakage current and breakdown strengths are correlated to structural defects and stoichiometry of the films.

The processing techniques involve oxygen plasma treatment and/or thermal oxidation of commercially available metal foils in air or oxygen rich atmosphere at elevated temperatures. The resulting oxide film serves as a dielectric while the unoxidized metal serves as one of the electrodes of the capacitor. The oxidized foils can be laminated to desired substrate with or without top metallization. The time and temperature of oxidation can be used to control the thickness of the films and resulting different capacitance densities. For example oxidation at 700° C. in air for 15 minutes resulted in a capacitance density of 90 nF/cm². Higher temperatures and longer oxidation times result in thicker films, lower capacitance densities and higher breakdown voltages. Despite, the lower capacitance density compared to ferroelectric thin films, these films are superior in term of processing required per nanofarad of capacitance. Also, the foils can also be oxidized in-situ during manufacturing by controlling the process atmosphere further reducing the cost.

Presented below is a characterization of structure electrical property relationships of hydrothermal and sol-gel barium titanate films. The effect of process parameters on film composition and crystal defects using techniques such as SEM, Xi FTIR and Raman spectroscopy are discussed. XPS in conjunction with depth profiling is used to study the composition of the films through the thickness of the films prepared under various conditions. FTIR and Raman spectroscopy are used to provide information about the defects in the crystal structure like entrapped hydroxyl groups and resulting lattice distortions. These results explain the observed i-V behavior of the hydrothermal and sol-gel barium titanate films. Different concentrations of Mn are evaluated in order to minimize the leakage current.

Also presented below is a discussion of the synthesis of thin films via hydrothermal, sol-gel and RF-sputtering techniques. Of these three techniques, hydrothermal is a low temperature process and can be used to synthesize films directly on organic Printed Wiring Boards. Sol-gel and RF-sputtering require high temperature sintering to produce crystalline films. Hence films were synthesized on free standing foils that can be laminated on to organic boards. In addition, a novel process involving thermal oxidation of metal foils is presented below.

### Hydrothermal Synthesis

In the past decade, there has been tremendous interest in hydrothermal synthesis techniques, which can yield crystalline barium titanate films and powders at temperatures less than 100° C. Several authors have reported synthesis of thin films by hydrothermal treatment of metallic titanium, such as, Wu, Z.; Yoshimura, M., “Investigations on procedures of the fabrication of barium titanate ceramic films under hydrothermal-electrochemical conditions”, Solid State Ionics, Diffusion & Reactions, vol. 122, No. 14, pp. 161172, and spun-on organic precursors of titanium is discussed by M. A. McCormick and E. B. Slamovich, “Effect of precursor pyrolysis on the dielectric properties of hydrothermally derived barium titanate thin films” J. Am. Ceram. Soc., v 83, n 2, February 2000, p 442-4. Films synthesized from organic precursors are typically porous presumably because of low titanium content in the precursor films. Hence, the precursor films are densified at high temperatures (>300° C.) prior to hydrothermal synthesis, such as is disclose by M. A. McCormick and E. B. Slamovich, “Microstructure development and dielectric properties of hydrothermal BaTiO₃ thin films”, J. Eur. Ceram. Soc. v. 23, n. 12, 2003, pp. 2143-52. Hydrothermal synthesis, as the name implies, involves synthesis in aqueous solutions at elevated temperatures. Specifically, synthesis of barium titanate involves reacting a source of titanium with Ba²⁺ ions under alkaline conditions. With consideration of cost and organic compatibility in mind, titanium foils were chosen over evaporated titanium and organic precursors. Evaporated titanium is generally incompatible with large area board processing. Organic precursors on the other hand require high temperature pyrolysis.

12 μm thick titanium foils (Alfa Aesar, Ward Hill, Mass.) were laminated on bare FR4 using epoxy prepreg. The titanium surface was cleaned using oxygen plasma to remove grease and other impurities that inhibit hydrothermal reaction. The laminated foils were immersed in barium hydroxide solution at 90° C. for 6-24 hours. Higher temperatures improve the reaction kinetics. The foils were subjected to post-hydrothermal oxygen plasma treatment to improve yield, reduce leakage and dielectric loss.

Alternatives of this method involve using a metallic titanium reactive metal layer on an organic substrate with copper or other conductive layers and then hydrothermally grow the high-k film.

Another alternative of this method is to use a titanium organic precursor layer on an organic substrate with copper or other conductive layers and then hydrothermally grow the high-k film. Several publications exist where the titanium precursor is pyrolyzed at high temperatures to get rid of the organic content before doing hydrothermal. The present invention involves the use of organic compatible temperatures to bake the films without the need for high-temperature pyrolysis.

An alternative to high temperature pyrolysis is an oxygen plasma treatment of the precursor films to eliminate most of the organic content before doing the hydrothermal process.

The titanium organic precursor layer is deposited as a thin film to prevent cracking and is baked at 160° C. to remove some organic content. The process is repeated multiple number of times if necessary to increase the film thickness. Because the process involves coating ultrathin films, common precursors may be used without a problem with cracking. By repeating this step, the yield and manufacturability for large-volume with good properties can be obtained without compromising the quality of the films.

Hydrothermal techniques enable synthesis of crystalline barium titanate films at temperatures as low as 95° C., but with poor yield and loss. The present techniques eliminate high temperature heat treatments resulting in barium titanate thin films with a capacitance density of 1 μF/cm² and a dielectric loss of 0.06. Post-hydrothermal baking, oxygen plasma treatment, and so forth. reduce the leakage current and tremendously improve the properties.

### Sol-Gel Synthesis

Using nickel as an oxidation barrier has been developed by Oakmitsui Company. Several publications exist on synthesizing films directly on copper foils with no barrier layers. These however, require complex sintering profiles to prevent oxidation of the copper foil. Sol-gel synthesis unique to the present invention uses titanium or other reactive layers specified that react in a controlled way to prevent oxidation of the copper foil. The titanium barrier reacts with the sol-gel layer to form a high-k layer directly on the copper foils. In this way, the pyrolysis and sintering treatments can be much simpler because titanium protects the underlying copper.

By way of example, barium granules (Aldrich chemical company), titanium (IV) isopropoxide Ti[OCH(CH3)2]4 (Alfa), tin (II) ethoxide (Alfa), manganese (II) acetyl acetonate (Aldrich) and 2-methoxyethanol (2-MOE) (Aldrich) as solvent were the starting materials for the synthesis of BaTiO₃ and doped BaTiO₃ with 0.01, 0.03, and 0.05 Sn/Mn by sol-gel synthesis. Initially, the Ba granules were dissolved in 2-MOE in a flask and refluxed at 125° C. for 5 hours in argon atmosphere. The precursor solution was cooled to room temperature and then the stoichiometric amount of titanium (IV) isopropoxide, along with 2-MOE as solvent, were added and refluxed at 125° C. for 5 hours in argon atmosphere to obtain a clear BaTiO₃ precursor solution. In the case of doped BaTiO₃ the Sn/Mn precursors were added after the refluxing barium precursor solution with Titanium precursor and finally the solution was refluxed at 125° C. for 6 hours in argon atmosphere. 0.4 M concentration solutions were used. The final compositions synthesized were BaTiO₃, [Ba (TiO Mn/Sn_{0.01})O₃], [Ba(Ti_{0.97} Mn/Sn_{0.03})O₃] and [Ba(Ti_{0.95} Mn/Sn_{0.05})O₃].

The doped and undoped BaTiO₃ precursor solutions were spin-coated (P-6000, Integrated Technologies, Acushnet, Mass.) on Copper foils with the reactive barrier layer. Spin coating was done at 3000 rpm for 30 seconds. Rapid pyrolysis of the precursor films was achieved by placing them on a hot plate at 380° C. for about 3 minutes in air in order to remove most of the organic groups. By repeating this process for 3 times, thicker films with higher electrical yield were obtained. These amorphous films were subsequently converted into crystalline doped and undoped BaTiO₃ films by heat treating at various temperatures and sintering atmospheres using Rapid Thermal Process (AET addax, model RX). The heat treatment atmospheres were air, oxygen, N₂ or forming gas.

The sol-gel technique involves sintering spun-on organic precursors, and allows integration of pure and doped ceramic films into organic PWBs by using a foil transfer technique. In addition, the sol-gel technique allows controlled tuning of the film chemistry by dopants/additives to improve temperature coefficient of capacitance, loss leakage current and breakdown voltage. For sol-gel films, divalent dopants can compensate for the oxygen vacancies and improve the DC leakage properties.

### RF-Sputtering

RF sputtering unique to the present invention uses titanium or similar metals as the reactive layer while simultaneously preventing oxidation of the copper foil. The titanium barrier reacts with the sputtered layer in a controlled way to form a high k layer directly on the copper foils. By way of example, RF-sputtered barium titanate films were deposited using a 99.9% pure barium titanate target (Kurt J. Lesker Company). To explore the feasibility of integration on silicon as well on the substrate, films were deposited on both platinum coated silicon and nickel coated copper foils. The substrate was heated to 300° C.-350° C. during deposition. The target was mounted on a copper backing plate and a prescribed ramp rate of 10 W per minute was used during power-up in order to minimize the cracking of the targets due to non-uniform heating.

The dielectric properties of titanate perovsksites are shown to depend on the gas ratio of O₂/(Ar+O₂) (referred to as OMR) during RF-sputtering of films. Dielectric constant increases with the oxygen content and reached a maximum value at 50% oxygen content while the leakage current is lowest for 40% oxygen, as is disclosed by M. S. Tsai, S. C. Sun, T. Y. Tseng, “Effect of oxygen to argon ratio on properties of (Ba,Sr)TiO₃ thin films prepared by radio-frequency magnetron sputtering”, J. Appl. Physics, 82, 1997, 3482. In this analysis, the Ar:O₂ ratio used was 2:1. Permittivity is shown to increase with film thickness (varies from 150 to 300) as film thickness varies from 50 run to 200 nm and then saturates. Decreased grain size, increased contribution of the low K phases at the ceramic-metal interface are attributed to this behavior. For single crystal substrates such as silicon and sapphire, increased deposition temperatures lead to more orientation resulting in improved properties, as is disclosed by P. Padmini, T. R. Taylor, M. J. Lefevre, A. S. Nagra, R. A. York, J. S. Speck, “Realization of high tunability barium strontium titanate thin films by rf magnetron sputtering”, Applied Physics Letters, v. 75, n. 20, Nov. 15, 1999, p. 3186-3188, and V. E. Loginov, E. K. Holhnann, A. B. Kozyrev, A. M. Prudan, Preparation of SrTiO₃ films on sapphire substrate by RF magnetron sputtering, Vacuum, v. 51, n. 2, October 1998, p. 141-3. Lowered oxygen content in the deposition chamber is also shown to improved texture. Padmini et al. have shown that increasing the Ar/O₂ ratio to 9:1 gave the highest texture in BST leading to highest tunability in the dielectric constant (4:1). From previous studies, post-annealing treatments in N₂/forming gas environment increasing the leakage current while oxygen annealing lowered the leakage current, as is disclosed by J. H. Joo, J. M. Seen, Y. C. Jeon, K.-Y. Oh, J. S. Roh and J. J. Kim, “Improvement of leakage currents of Pt/(Ba,Sr)TiO₃/Pt capacitors”, Appl. Phys. Let., 70, 1997, 3053.

As-deposited films were mostly amorphous with low dielectric constant. Hence, several post deposition annealing treatments were explored to improve the dielectric properties.

### Reactively Grown Titanium Oxide

A novel low-cost method of making titanium oxide films was implemented. Titanium oxide is a paraelectric material with moderate dielectric constant. However, due to its paraelectric nature, it exhibits frequency independent dielectric properties and high break-down voltages. The method involves thermal oxidation of commercially available titanium foils and subsequently laminating the foil onto virtually any substrate. The time and temperature of oxidation may be used to control the thickness of the films. Higher temperatures and longer times result in thicker films with low capacitance densities and higher breakdown voltages. While the capacitance density of these films is lower than that of ferroelectric thin films, this material-process system is superior in terms of cost per nanofarad of capacitance. The method can be extended to Ti coated copper foils, followed by thermal oxidation. If low temperatures are used, the Ti-coated organic substrates can be directly used.

### Electrical Characterization

Capacitance measurements were performed at 100 kHz using an LCR meter. In the case of hydrothermal films, the unreacted titanium served as the bottom electrode. Copper with or without the Ti barrier, served as bottom electrode for sol-gel and RF-sputtered films. The top electrode in all cases was gold evaporated through a shadow mask.

### Structural Characterization

High resolution Field Emission Scanning electron microscopy was used to study the morphology of the films. Thickness of the films was estimated from the SEM cross-sections. X-ray diffraction was used for characterizing the crystallinity of the films. The stoichiometry of the sol-gel and RF-sputtered films was studied using Energy Dispersive X-ray Spectroscopy. Due to certain limitations described later, XPS in conjunction with depth profiling was used to study the hydrothermal films.

### Results and Discussion

Hydrothermal Barium Titanate Films:

As synthesized hydrothermal films showed crystalline cubic structure. The grain size from SEM micrographs was estimated to be 80-100 nm. It is well known that As-synthesized hydrothermal films contain a large concentration of entrapped hydroxyl groups. These hydroxyl groups are objectionable as they lead to high loss, poor yield and small breakdown voltages. Post hydrothermal heat-treatments have been shown to reduce the concentration of hydroxyl groups. A novel low temperature oxygen plasma treatment was developed to reduce the concentration of hydroxyl groups and improve the properties of hydrothermal films. The dielectric properties of the films are summarized in Table 1.

TABLE 1
Summary of dielectric properties of hydrothermal films.

| | Specific Dielectric | Capacitance(nF/cm²) |
|---|---|---|
| As-synthesized | 3000 | 0.28 |
| Plasma treated | 1250 | 0.07 |

Effect of Oxygen Plasma:

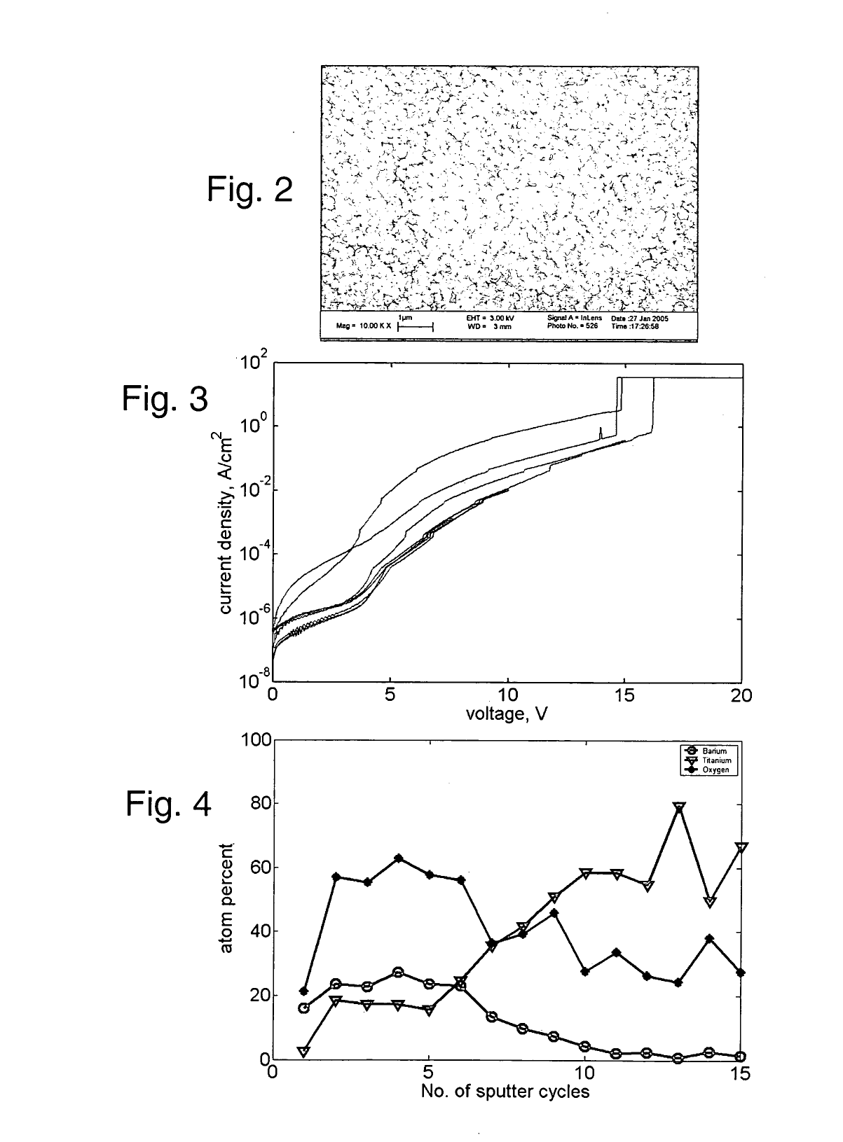

The oxygen plasma treatment has been shown to reduce the entrapped hydroxyl groups in the hydrothermal films using FTIR and Raman analysis (see for example, D. Balaraman, et al, “BaTiO₃ Films by Low-temperature Hydrothermal Techniques for Next Generation Packaging Applications”, J. of Elec. Ceramics, 13, 95-100, 2004). However, under certain conditions, the plasma treatment can physically damage the film. FIG. 2 shows the microstructure of an exemplary film treated at a pressure of 300 mTorr and a power of 400 W in a 12 foot chamber. In particular, FIG. 2 illustrates an SEM micrograph of hydrothermal films showing the effect of oxygen plasma treatment. (a) Films treated with 300 mT, 400 W plasma. The microstructure of the films is preserved after the 300 mT-400W plasma treatment. Higher power sputters the film away. Hence, 300 mT-400W plasma was used for all subsequently-produced films.

The DC leakage characteristics of the hydrothermal films are shown in FIG. 3. More particularly, FIG. 3 shows the dependence of leakage characteristics of exemplary hydrothermal barium titanate films on reaction times. The best hydrothermal films in this study exhibited a breakdown voltage of around 15 V. The reaction times do not seem to affect the breakdown voltage. However, the leakage currents decrease with increasing reaction times.

A breakdown voltage of 15 V across a 300 nm film corresponds to breakdown strength of 0.5 MV/cm. The breakdown strength of thin-film barium titanate reported in the literature is around 0.5 MV/cm (see, for example, Jam, P., Rymaszewski, E. J., IEEE Transactions on Advanced Packaging, v. 25, n. 3,454-458, 2002). There are a number of factors that affect the DC leakage characteristics of thin ceramic films. These include crystal defects like vacancies, impurities and non-stoichiometry.

Attempts to study the composition of the hydrothermal films using Energy Dispersive X-ray Spectroscopy (EDS) were not fruitful. EDS technique relies on characteristic x-rays emitted by constituent elements in the film, when the film is bombarded with high energy electron beam in a Scanning Electron Microscope. During the analysis of barium titanate films grown on titanium foils, the spectrum was skewed by titanium below the film. This may be because of large electron energies required for exciting barium. Hence X-ray Photospectroscopy (XPS) with depth profiling was explored to study the film composition.

XPS is a surface analysis technique where the surface to be analyzed is irradiated with x-rays and the energies of emitted photoelectrons are analyzed to identify the constituent elements. While the x-rays have penetration depths in the vicinity of a micron, the escape depth of photoelectrons produced is small, making XPS an attractive surface analysis technique. Further, the film can be sputtered using an ion beam and the composition of the film across its thickness can be obtained. FIG. 4 shows the XPS depth profile of exemplary hydrothermal films synthesized in 2M Ba(OH)₂ solution at 95° C. Upon progressively sputtering the film, it was found that films were stoichiometric over a certain depth, with Ba:Ti:O=1:1:3 as expected for BaTiO₃. After sputtering top few layers it was found that while the strength of barium signals dropped quickly to negligible levels, signal from oxygen persisted past the thickness of stoichiometric barium titanate. This may be attributed to high oxygen affinity of titanium surface which may be scavenging any available oxygen from the XPS chamber resulting in high oxygen concentration. However, the possibility of presence of an amorphous titanium oxide layer below the film cannot be ruled out.

With the film being stoichiometric, the observed leakage current and breakdown voltages can be attributed to entrapped hydroxyl groups in the film. Unfortunately, the XPS technique does detect hydrogen and hence cannot be used to study entrapped hydroxyl groups.

With capacitance density in the vicinity of a microfarad/cm² and stable dielectric properties in the GHz frequencies, hydrothermal barium titanate films should be able to address the decoupling needs in high frequency circuits.

Titanium Oxide Film:

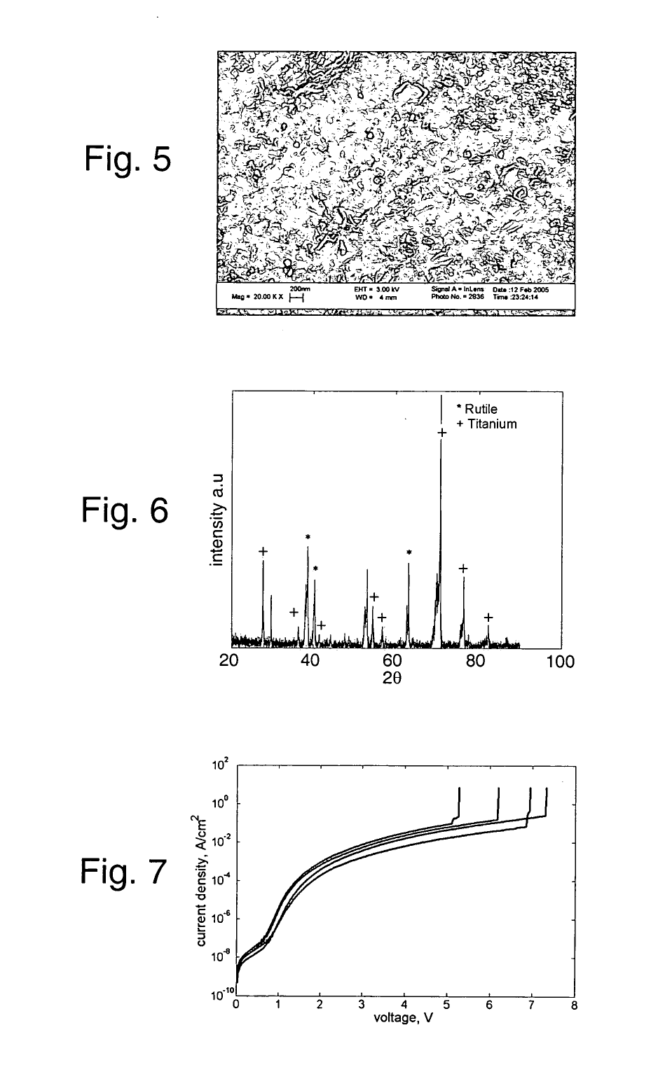

Titanium exhibits a large affinity for oxygen resulting in a thin native oxide on the surface. However, the native oxide is extremely thin and fragile for most practical applications. Oxidation of metallic titanium at elevated temperatures yields a dense oxide film which can serve as thin film dielectric for embedded capacitors. The film is paraelectric in nature and hence the dielectric properties are expected to exhibit little or no frequency dependence. The thickness of the films can be controlled by varying the time and temperature of oxidation. The microstructure of such films thermally grown on titanium foil is shown in FIG. 5. FIG. 6 illustrates an XRD pattern of exemplary thermally oxidized titanium foils showing a mixture of titanium oxide phases.

A summary of the dielectric properties of f exemplary films synthesized on 12 micron thick titanium foils is summarized in Table 2.

TABLE 2
Summary of electric properties of thermally grown TiO₂ films

| Time | Capacitance density | Loss |
|---|---|---|
| 15 mm | 100 nF/cm² | 0.06 |
| 6 mm | 230 nF/cm² | 0.30 |

As seen in FIG. 7 thermally grown titanium oxide films exhibit breakdown voltages >5 V and low leakage currents at IV. FIG. 7 shows leakage current characteristics of thermally grown titanium oxide films. In applications where the use of titanium as one of the electrodes is objectionable, titanium may be evaporated/sputtered on a copper foil and subsequently oxidized.

Sol-Gel Derived Perovskite Films:

Sol-gel synthesis is a versatile technique that can yield a variety of ceramic thin films with controlled composition, properties, purity and thickness. It offers a capability to introduce dopant into films to enhance the dielectric properties such as DC leakage and dielectric loss. In addition, compared to low temperature aqueous hydrothermal process, sol-gel synthesis can be expected to deliver defect-free thin films coming from ultra pure starting materials and high processing temperature.

Table 3 shows the capacitance density of sol-gel films on nickel-coated copper foils for different annealing times in air. The capacitance densities (200-300 nF/cm²) were relatively low compared to what is expected from completely crystalline films because of the shorter annealing times (30 seconds to 1 minute). Longer annealing times (3-15 minutes) in air did not improve the capacitance densities either because the nickel barrier was not very effective in controlling the oxidation. Nickel oxide peaks were observed in the XRD pattern of the heat-treated foils. The oxidized foil showed abnormal grain growth and discontinuity in the sol-gel coating. As stated above, the thermally grown oxide forms an insulating dielectric, leading to high yield even with these sol-gel films. Crystalline films on bare copper foils and nickel foils with careful control of sintering atmospheres has previously been reported by Ihiefeld et al. in Cu-compatible ultra-high permittivity dielectrics for embedded passive components, Materials, Integration and Packaging Issues for High-Frequency Devices Symposium, 2004, pp. 145-50, and Dawley et al in “Dielectric properties of random and <100> oriented SrTiO₃ and (Ba,Sr)TiO₃ thin films fabricated on <100> nickle tapes”, Applied Physics Letters, (2002), Vol. 81, No. 16, pp. 3028-3030. The XRD of barium titanate films for 1 hr annealing is compared with those from 30 second and 60 second annealing in FIG. 10. The films are not completely crystalline leading to low capacitance densities. In our studies, films annealed in nitrogen atmosphere for 1 hour showed a capacitance density above 500 nF/cm² for a 300 nm film corresponding to an effective dielectric constant of 170. More accurate control of oxygen partial pressure with complete control of reacting phases is essential to realize higher capacitance densities.

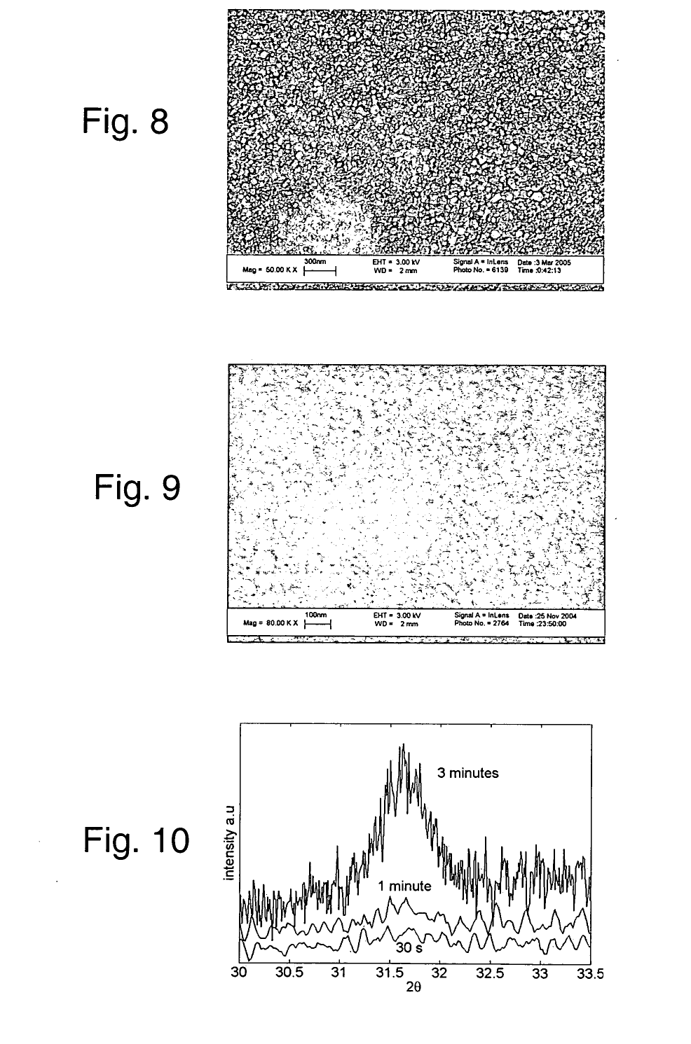

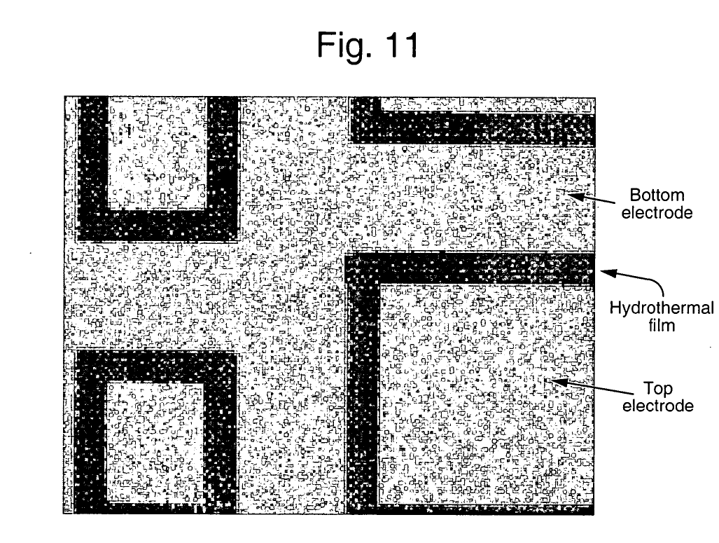

FIG. 8 shows a SEM micrograph of sol-gel films showing nano-grained sol-gel barium titanate.

FIG. 10 shows the structural evolution of sol-gel barium titanate films with annealing times.

TABLE 3
Properties of RF-sputtered and sol-gel derived BT films on copper foils
with a reactive nickel layer, annealed for different times at 700° C.
for organic compatible embedded capacitors.

| | | | |
|---|---|---|---|
| | Capacitance density | | Leakage (A/cm²)@IV/ |
| Time | (nF/cm²) | Loss | Breakdown voltage (V) |

RF-sputtered barium titanate

| | | | |
|---|---|---|---|
| — | 110 | 0.01 | 10⁻⁸/>10 |
| 30 s | 230 | 0.04 | 2 × 10′⁻¹⁰/>10 |

RF-sputtered strontium titanate

| | | | |
|---|---|---|---|
| — | 400 | 0.10 | 10⁻⁵/>10 V |
| 60 s | 180 | 0.03 | 10′⁻⁷/>6 V |

Sol-gel derived barium titanate

| | | | |
|---|---|---|---|
| 60 s | 135 | 0.06 | 7 × 10⁻⁵/6.5 |
| 20 s | 135 | 0.08 | 2.0 × 10′⁻⁵/2 |
| 30 s | 120 | 0.07 | 1 V |

Sol-gel derived strontium titanate

| | | | |
|---|---|---|---|
| 60 s | 200 | 0.10 | 0.001/5 |
| 30 s | 80 | 0.05 | 0.005/5 |
| 1 hr (N₂) | 500 | 0.05 | 1 × 10′⁻⁵⁴/3.5 |

FIG. 9 shows a SEM micrograph of barium titanate films sputtered at 350° C. followed by Rapid Thermal Annealing at 700° C. in air for 30 seconds.

In summary, several organic-compatible high-k thin film synthesis technologies have been described that provide for embedded capacitor applications.

Low temperature hydrothermal synthesis allows integration of crystalline barium titanate films on organic boards. They exhibit a capacitance density of about a microfarad/cm², highest reported capacitance density under 100° C. with near 100% yield for 1.5-2.00 mm capacitors.

Thermal oxidation of metal foils, leading to an insulating oxide film on the top, offers an elegant low-cost approach to realizing capacitances of 100 s of nano-farads/cm².

Sol-gel derived and RF sputtered titanate thin films with capacitance in the range of 100-400 nF/cm² can be integrated into organic packages using a foil transfer process with the reactive layer. Crystallinity of sol-gel films depends on the sintering conditions. While higher temperature and longer times are favorable for crystallization, they lead to deterioration of the nickel coated copper electrode foils due to instabilities at the nickel-copper interface. This problem can be avoided with Ti foils. Rapid Thermal Annealing conditions were optimized to achieve a capacitance density of 300 nF/cm² on copper foils with a 3 minute sintering cycle. RF sputtered strontium and barium titanate on copper foils with reactive layers were also explored. Strontium titanate was found to crystallize more readily than barium titanate at 350° C.

Thus, integrated capacitors and fabrication methods relating thereto have been disclosed. It is to be understood that the above-described embodiments are merely illustrative of some of the many specific embodiments that represent applications of the principles discussed above. Clearly, numerous and other arrangements can be readily devised by those skilled in the art without departing from the scope of the invention.

What is claimed is:

1. A capacitor integrated onto a substrate or foil formed by:
reacting a metal or precursor layer using a hydrothermal reaction, thermal oxidation or solid-state reaction with a deposited layer, to create a high dielectric constant film on the substrate that comprises the integrated capacitor.

2. The capacitor recited in claim 1 wherein the metal or precursor layer is selected from the group including titanium, niobium, zinc, chromium, silicon, nickel, tantalum, vanadium and derivative organic precursors thereof.

3. The capacitor recited in claim 1 wherein the high dielectric constant film is formed by hydrothermally reacting a metallic film with an alkaline bath.

4. The capacitor recited in claim 1 wherein the high dielectric constant film comprises a synthesized fine-grained high k film formed by hydrothermally reacting a titanium-organic compound with an alkaline bath.

5. The capacitor recited in claim 1 wherein the hydrothermal film is baked at about 250° C. in air, oxygen, or nitrogen to improve dielectric properties.

6. The capacitor recited in claim 3 wherein the hydrothermally formed film is treated with oxygen plasma to improve dielectric properties.

7. The capacitor recited in claim 3 the hydrothermally formed film comprises multiple hydrothermally formed thin films to prevent cracking.

8. The capacitor recited in claim 1 further comprising baking the high dielectric constant film at temperatures compatible with organics.

9. The capacitor recited in claim 1 wherein organic content of the high dielectric constant film is removed using oxygen plasma at relatively low temperatures.

10. The capacitor recited in claim 1 which is formed by:
laminating titanium foil or titanium coated copper foil onto an organic substrate;
treating the titanium precursor coating on an organic substrate using plasma; and
immersing the organic substrate and laminated foil in barium hydroxide solution at a predetermined temperature and for a predetermined time period.

11. The capacitor recited in claim 1 wherein the high dielectric constant film comprises a thermally-oxidized metal on an organic substrate or thermally oxidized metal foil that is later transferred onto an organic substrate.

12. The method recited in claim 11 wherein the thickness of the high dielectric constant film is controlled by the time and temperature of the thermal oxidation.

13. The method recited in claim 11 wherein the metal foil comprises multiple layers that reactively grow on the metal foil with properties having a desired performance level in terms of thermal stability.

14. The capacitor recited in claim 11 wherein the thermally-oxidized metal foil is selected from the group including titanium, nickel, vanadium and chromium, tantalum, zinc, and niobium.

15. The capacitor recited in claim 1 wherein the high dielectric constant film comprises a thermally oxidizable metal or precursor coating disposed on a metal foil that is later transferred to an organic substrate.

16. The capacitor recited in claim 1 which is formed using a reactive layer by:
preparing a metallorganic precursor solution using sol-gel synthesis;
spin-coating the precursor solution onto the substrate having a reactive layer formed thereon to produce a film;
pyrolyzing the film; and
heat treating the film to produce a high dielectric constant film by reacting the precursor with the reactive layer underneath to form the high dielectric constant film comprising an integrated capacitor.

17. The method recited in claim 16 wherein heat treating and reaction is performed in an air, oxygen, nitrogen or hydrogen environment directly on a organic substrate or on a foil which is then transferred onto an organic substrate.

18. The capacitor recited in claim 1 wherein the high dielectric constant film comprises a metallorganic precursor solution derived high dielectric constant film with the a reactive intermediate layer that also protects the underneath metal.

19. The method recited in claim 18 wherein the precursor solution is prepared by:
dissolving barium in 2-methoxyethanol solvent;
refluxing the dissolved barium in an argon atmosphere; to produce a precursor solution;
cooling the precursor solution to room temperature;
adding a stoichiometric amount of titanium (IV) isopropoxide to the precursor solution; and
refluxing the precursor solution in argon atmosphere to obtain a barium titanate precursor solution.

20. The method recited in claim 19 further comprising:
selectively adding dopant precursors and/or metals to the precursor solution containing barium and titanium (IV) isopropoxide prior to final refluxing.

21. The capacitor recited in claim 1 which is formed by forming a sputtered high dielectric constant film on a metal foil with a reactive intermediate layer, where the sputtered film reacts with the reactive intermediate layer by solid state reactions and forms the high dielectric constant layer.

22. The method recited in claim 21 where the sputtered film is a insulator that reacts with the intermediate layer to form the high dielectric constant layer.

23. The method recited in claim 21 where the sputtered film is a metal that reacts with the intermediate layer to form the high dielectric constant layer.

24. The method recited in claim 21 where the sputtered film and the reactive layer oxidize to form the high dielectric constant layer.

25. The method recited in claim 21 where the sputtered film and the reactive layer comprise dopants to improve film properties.
